(19) United States
(12) Patent Application Publication
(10) Pub. No.: US 2013/0249669 A1
(43) Pub. Date: Sep. 26, 2013

(54) METHOD AND DEVICE FOR OPENING AND CLOSING A DOOR AND/OR A TAILGATE OF A VEHICLE

(71) Applicant: Stefan Zwiener, Neuhausen (DE)

(72) Inventor: Stefan Zwiener, Neuhausen (DE)

(73) Assignee: DAIMLER AG, Stuttgart (DE)

(21) Appl. No.: 13/822,331

(22) PCT Filed: Nov. 19, 2011
(86) PCT No.: PCT/EP11/05837

§ 371 Date: Mar. 12, 2013

(30) Foreign Application Priority Data
Dec. 16, 2010 (DE) 10 2010 054 625.9

(51) Int. Cl. G06F 21/32

(52) U.S. Cl. CPC G06F 21/32
USPC 340/5.53

(57) ABSTRACT

A method and a device for opening and closing a door (6.1) and/or a tailgate (6.2) of a vehicle (7), with which a person authorized to enter the vehicle is recognized and a movement of the authorized person is detected. The detected movement of the authorized person is analyzed and the opening and closing of the door (6.1) and/or tailgate (6.2) is initiated when the authorized person is recognized and the detected movement of the authorized person is identified as a previously determined movement.

The invention relates to a method and a device for opening and closing a door and/or a tailgate of a vehicle, by means of which a person authorized to enter the vehicle is recognized and a movement of the authorized person is detected.

In DE 10 2009 030 274 A1 disclosure is made of a system for opening and shutting a door, a hatch, a tailgate, or the like of a vehicle. The system comprises a device with a recognition means for recognizing a person authorized to enter the vehicle and a positioning means operating coactively with the recognition means by means of which the door, the hatch, the tailgate, or the like can be opened or closed. By means of a motion detector associated with the recognition means, a movement of the person, in particular the authorized person, is detected and the opening or closing of the door, the hatch, the tailgate, or the like is initiated by the movement of the authorized person.

The object of the invention is to propose an improved method as well as an improved device over the prior art for opening and closing of a door and/or a tailgate of a vehicle.

The object is achieved according to the invention by a method with the features stated in claim 1 and a device with the features stated in claim 4.

Advantageous improvements of the invention are the subject of the dependent claims.

A method for opening and closing a door and/or a tailgate of a vehicle recognizes a person authorized to enter the vehicle, for example, in the immediate vicinity of the vehicle and detects a movement and/or facial features of the authorized person.

According to the invention, the detected movement and/or facial features of the authorized person is/are analyzed and the opening and closing of the door and/or tailgate is then initiated if the authorized person is recognized and the detected movement and/or facial features is/are identified as a previously determined movement or as previously stored facial features.

The previously determined movement or the facial features are determinable by the authorized person. Alternatively, the manufacturer may determine the previously determined movement when the vehicle is manufactured.

Provision is thus made of a method in which the person authorized to enter the vehicle can open or close the door, e.g., a driver door and/or the tailgate of the vehicle with the aid of a determinable movement, for instance a quick stamping of the authorized person's foot on the ground, and/or his/her facial features, provided that the authorized person so desires. This is particularly advantageous in the event that the hands of the authorized person are full with, say, luggage and/or in the event of chronic or temporary voice or speech impediments.

As for the device for opening and closing the door and/or a tailgate of a vehicle, the latter comprises a recognition means for recognizing a person authorized to enter the vehicle, a detection unit associated with the recognition means with which a movement and/or facial features of the authorized person is/are detectable, and a positioning means operating coactively with the recognition means by which the door and/or tailgate can be opened and closed. A previously determined movement and/or facial features is/are expediently stored in the detection unit, wherein the detected movement and/or facial features of the authorized person can be analyzed and an opening and closing of the door and/or tailgate can be initiated if the detected movement can be identified as the previously determined movement and/or detected facial features can be identified as previously stored facial features.

The detection unit herein is a detection unit already in use for other driver assist systems integrated in the vehicle, such as a rear view backup camera mounted in the back of the vehicle for monitoring a vehicle environment. By using a detection unit already installed in the vehicle, the weight and production costs of the vehicle are reduced and optimum use of the installation space of the vehicle is possible.

Exemplary embodiments of the invention are explained in more detail in the following, with reference to a drawing.

Shown is:

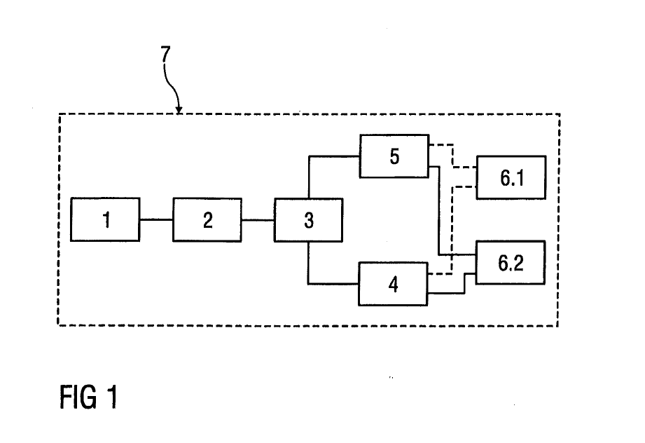

FIG. 1 a block diagram with functional units of a device for explaining a method for opening and closing a door and/or a tailgate of a vehicle.

Corresponding parts have the same reference signs in all figures.

FIG. 1 shows a block diagram of a device comprising a detection unit 1 with a control unit 2, a recognition means 3, a positioning means 4, a locking system 5, and a door 6.1 and/or tailgate 6.2 for explaining a method for opening and closing the door and/or tailgate 6.2 of a vehicle 7.

The vehicle 7 is advantageously configured as a car and is illustrated schematically in dashed lines.

In the event that a person approaches, say, a rear end of the vehicle 7, the opening of the closed tailgate 6.2 takes place according to the method for opening and closing the door and/or a tailgate 6.2 as follows:

After the person has approached the rear end of the vehicle 7, the detection unit 1 detects the person and a movement and/or facial features of the person.

The detection unit 1 is advantageously configured as a rear end-mounted backup camera of the kind also used, for example, for monitoring the rear end for other driver assist systems such as collision prevention systems.

A reduction of the weight and manufacturing costs of the vehicle 7 and optimum use of the installation space of the vehicle 7 are thus possible.

After the person has been detected by the detection unit 1 in a detection area of said detection unit 1 by his/her movement and/or facial features, this information is sent to the control unit 2 (for example, a microcontroller) associated with the detection unit 1.

The control unit 2 analyzes the information sent by the detection unit 1, wherein the detected movement of the person and/or facial features is/are compared with a previously determined movement and/or facial features stored in the control unit 2. For example, an image sequence of a previously determined movement is stored in the control unit 2 in the form of a suitable algorithm.

The previously determined movement can be defined as, for example, a quick stamping of the person's foot on the ground. Furthermore, the previously determined movement is determinable by, for example, a vehicle owner. Alternatively, the previously determined movement is determined by the manufacturer when the vehicle 7 is produced. Images with facial features can also be stored in the control unit 2 and analyzed using prior art algorithms for facial recognition.

If the movement of the person detected by the detection unit 1 and then analyzed by the control unit 2 is identified as the previously determined movement and/or analyzed facial features are identified as previously stored facial features, the control unit 2 sends a signal such as an initiation code to the recognition means 3. The recognition means 3 then checks whether the person is an authorized person. To this end, use is made of, for example, a keyless go system. Alternatively, the recognition means first becomes active and the detection unit is only then activated after positive identification of the authorized person. Hence the detection unit advantageously remains inactive until the approach of an authorized person and therefore does not consume current, which saves the vehicle battery.

The keyless go system sends one or a plurality of coded signals via an on-board transponder integrated in the vehicle 7. If the person is carrying a mobile transponder corresponding to the transponder in the form of, say, a vehicle key, the mobile transponder responds to the radio signal or signals of the transponder by sending one or a plurality of coded radio signals.

In the event of a positive identification of the mobile transponder, the opening of the tailgate 6.2 is initiated or enabled. The opening is effected by an electric and/or hydraulic actuator (not shown) which is powered by the positioning means 4, wherein the positioning means 4 is arranged on the inside in a rear opening of the vehicle 7 and has an arm by means of which the tailgate 6.2 is pivoted.

Thus provision is made of a method with which the authorized person can only open or close the tailgate 6.2 with a previously determined movement and not with a random movement. This is especially advantageous if, for example, the authorized person with the mobile transponder is in the vicinity of the vehicle, for instance, in back of the vehicle, and another person or animal moves simultaneously within the detection area of the detection unit 1. The method only initiates the opening or as the case may be, closing of the tailgate 6.2 if the authorized person makes the previously determined movement.

The detection device 3 can operate coactively with the locking system 5 of the vehicle 7 such that when the tailgate 6.2 is locked, an unlocking is initially effected by the locking system 5.

Alternatively, as an additional command signal for opening and/or closing the tailgate 6.2, use can be made of a facial recognition means that is associated with the recognition means 3 and with which the opening and/or closing of the tailgate 6.2 can be initiated.

Alternatively, as an additional command signal for opening and/or closing the tailgate 6.2, use can be made of a speech recognition means that is associated with the recognition means 3 and with which the opening and/or closing of the tailgate 6.2 can be initiated.

In the event that a person moves, for example, away from the rear end of the vehicle 7, the method works in a similar manner:

After the person has removed, say, an item of luggage from the vehicle 7 and has moved away from the latter, the detection unit 1 detects a person moving away and a movement of the person moving away and transmits this information to the control unit 2.

The control unit 2 analyzes the detected movement of the person moving away and compares it to a previously determined movement stored in the control unit 2.

If the movement of the person detected by the detection unit 1 and then analyzed by the control unit 2 is identified as the previously determined movement, the control unit 2 sends a signal, which can likewise be an initiation code, to the recognition means 3.

The recognition means 3 checks, for example by means of a keyless go system as described above, whether the person moving away is an authorized person.

In addition to the recognition of the mobile transponder it can be determined by, for example, the response to the radio signals of the on-board transponder whether the person carrying the mobile transponder is actually going away. For example, this can be accomplished by measuring and comparing the reception time between the radio signals sent by the mobile transponder.

In the positive case, the closing of the tailgate 6.2 is effected by the positioning device 4, wherein the tailgate 6.2 can be locked by means of the locking system after the tailgate 6.2 has been closed.

The closing and optionally also the locking of the tailgate 6.2 is thus possible if the hands of the person are not free because of, for example, carrying two items of luggage. The person does not need to set the luggage down on the street in order to be able to close the tailgate 6.2 of the vehicle 7 him/herself. This would be disadvantageous for a variety of reasons, such as a dirty street or a heavy load to lift.

In an alternative embodiment, the method can also be employed for opening and closing the door 6.1, e.g., a vehicle door. The detection unit 1 is then configured as, say, a camera arranged in an outside rear-view mirror of the door 6.1.

### LIST OF REFERENCE NUMERALS

1 Detection unit
2 Control unit
3 Recognition means
4 Positioning means
5 Locking system
6.1 Door
6.2 Tailgate
7 Vehicle

1. A method for opening and closing at least one of a door (6.1) and a tailgate (6.2) of a vehicle (7), by means of which a person authorized to enter the vehicle (7) is recognised and a movement of the authorized person is detected, comprising:
analyzing at least one of the detected movement and detected facial features of the authorized person and
initiating the opening and closing of at least one of the door (6.1) and tailgate (6.2) if the authorized person is recognized and at least one of the detected movement and the detected facial features of the authorized person is/are identified as at least one of a previously determined movement and previously stored facial features.

2. The method according to claim 1, wherein electronic codes are used for recognizing the authorized person.

3. The method according to claim 1, wherein at least one of the door (6.1) and tailgate (6.2) is/are opened or closed by means of at least one of an electric and hydraulic actuator.

4. A device for opening and closing at least one of a door (6.1) and a tailgate (6.2) of a vehicle (7) comprising:
a recognition means (3) for recognizing a person authorized to enter the vehicle (7),
a detection unit (1) associated with the recognition means (3) with which at least one of a movement and the face of the authorized person can be detected, and
a positioning means (4) operating coactively with the recognition means (3) with which the door (6.1) and/or the tailgate (6.2) can be opened and closed, wherein in the detection unit (1) is stored at least one of a previously determined movement and facial features of at least one person, wherein the detected movement and/or facial features of the authorized person can be analyzed and an opening and closing of the door (6.1) and/or tailgate (6.2) can be initiated if the detected movement and/or the detected facial features can be identified as the previously determined movement and/or as previously stored facial features.

5. The device according to claim 4, wherein the detected movement and/or facial features can be analyzed by means of a control unit (2) associated with the detection unit (1).

6. The device according to claim 4, wherein the detection unit (1) is a camera.

7. The device according to claim 4, wherein the recognition means (3) operates coactively with a locking system (5) of the vehicle.
